(19) United States
(12) Patent Application Publication
(10) Pub. No.: US 2007/0105528 A1
(43) Pub. Date: May 10, 2007

(54) System and method for communicating emergency data

(76) Inventors: Juergen Haas, San Diego, CA (US); Keith A. Buckley, Darien, CT (US)

Correspondence Address: Kevin M. Farrell;Pierce Atwood, Suite 350, One New Hampshire Avenue, Portsmouth, NH, 03801, US

(21) Appl. No.: 11/271,326

(22) Filed: Nov. 10, 2005

(51) Int. Cl. H04M 11/04

(52) U.S. Cl. 455/404.1; 455/466

(57) ABSTRACT

The present invention includes a system and a method for communicating emergency data. In its various embodiments, discussed in detail below, the present invention provides an interface between at least one mobile device and at least one data center, the latter of which is preferably networked such that it can be accessed through normal Internet protocols. The system of the present invention further provides for a network gateway that links the mobile device to the data center and provides means for translating information usable by the mobile device into information usable by the data center. In its more preferred embodiments, the emergency data is communicated according to two protocols, including HTTP, MMS, WAP or SMS, a first of which applying to communications with the data center and a second of which applying to communications with the mobile device.

### BACKGROUND OF THE PRESENT INVENTION

1. Field of the Invention

The present invention relates generally to the field of telecommunications and more particularly to the field of personal data storage and transmission using conventional and wireless means.

2. History of the Related Art

The proliferation of highly portable computing devices such as mobile telephones, personal data assistants, laptop computers, MP3 players, and other mobile personal computing devices has allowed people access to a great deal of information at their fingertips. In general, various types of users have found these devices useful for things ranging from running fairly complex programs, such as to browse the web or access email, to simpler tasks such as storing contact information, keeping a calendar, and so forth. Moreover, the integration of multiple functions within more powerful and compact devices has allowed users to consolidate many of these functions into very few or perhaps even a single hardware element.

A side effect of the increasing mobility of modern society is the increased risk of encountering an emergency situation outside of one's home, school or office. Moreover, as the amount of information in modern society increases, there is even more input that is needed in an emergency situation in order for a user or first responder to make accurate and safe decisions. For example, a user in an emergency situation might be expected to access a significant amount of information from different sources, such as a phone number for road-side assistance, their vehicle's identification (VIN) number, physician contact information, insurance information, and any information related to pre-existing allergies or maladies. Moreover, families and other groups may need these and other types of information for spouses, dependants, or employees. While even the most conscientious users may take the time to put such information in a computer system, the existing art is inefficient and limited in its ability to organize and transmit this data to a suitable mobile device that provides a user or first responder with easy access to relevant information. As such there is a need in the art for a system and method for storing, organizing and transmitting emergency data for use on a mobile computing device. The proposed solution should be both simple and elegant, such that users and first responders can readily access the emergency data in a crisis.

### SUMMARY OF THE PRESENT INVENTION

Accordingly, the present invention includes a system and a method for communicating emergency data. In its various embodiments, discussed in detail below, the present invention provides an interface between at least one mobile device and at least one data center, the latter of which is preferably networked such that it can be accessed through normal Internet protocols. The system of the present invention further provides for a network gateway that links the mobile device to the data center and provides means for translating information usable by the mobile device into information usable by the data center. In its more preferred embodiments, the emergency data is communicated according to two protocols, one that applies to communications with the data center and a second that applies to communications with the mobile device.

The method of the present invention is practicable through software or other means for operating a computer, database or mobile device. In particular, the method of the present invention includes steps for storing, receiving and transmitting emergency data according to a first protocol, storing, receiving and transmitting emergency data according to a second protocol, and a step for converting data between the first and second protocols. In practice, the method of the present invention includes steps for receiving, storing and transmitting data from a web-enabled data center to a mobile device, such as for example a mobile telephone; and further receiving, storing and transmitting data from the mobile device to the web-enabled data center. In this manner, the method ensures that a user's emergency data is always current and accurate, as the user can add, update or change his or her emergency data through both the web-enabled data center and the mobile device. Any changes or updates to the emergency data are communicated automatically to the complimentary element of the system.

These and other features and benefits of the present invention are more clearly and distinctly presented in the following detailed description made with reference to the Figures.

### BRIEF DESCRIPTION OF THE FIGURES

FIG. 1 is a schematic block diagram of a system for communicating emergency data according to one aspect of the present invention.

FIG. 2 is a schematic block diagram of the system for communicating emergency data according to additional embodiments of the present invention.

FIG. 3 is a screen shot of a mobile device operating in one mode according to the system and method of the present invention.

FIG. 4 is a screen shot of a mobile device operating in another mode according to the system and method of the present invention.

FIG. 5 is a screen shot of a mobile device operating in another mode according to the system and method of the present invention.

FIG. 6 is a screen shot of a mobile device operating in another mode according to the system and method of the present invention.

FIG. 7 is a screen shot of a mobile device operating in another mode according to the system and method of the present invention.

FIG. 8 is a screen shot of a mobile device operating in another mode according to the system and method of the present invention.

FIG. 9 is a screen shot of a mobile device operating in another mode according to the system and method of the present invention.

FIG. 10 is a screen shot of a mobile device operating in another mode according to the system and method of the present invention.

### DETAILED DESCRIPTION OF THE PREFERRED EMBODIMENT

The present invention relates to a system and method for communicating emergency data for use by an individual or first responder in an emergency situation. Generally, the present invention utilizes database applications configured for wireless devices, such as mobile telephones. The mobile devices are communicable with a networked database through both the wireless telephone network and the Internet such that an individual's personal data can be communicated through the mobile device at his or her location.

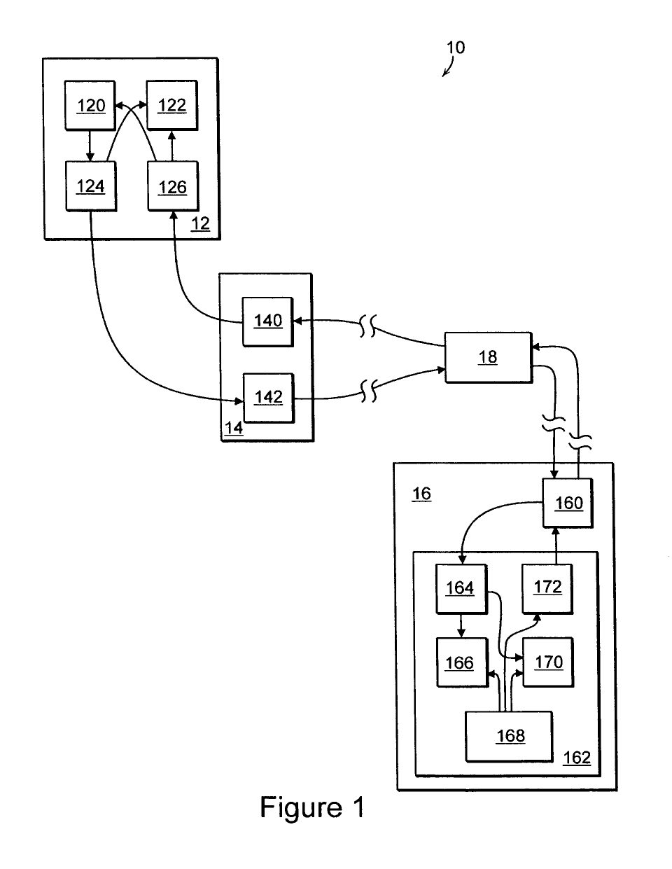

FIG. 1 is a schematic block diagram of the system 10 for communicating emergency data according to one aspect of the present invention. The system 10 includes a data center 12 that is connectable to a mobile device 16 through a network gateway 14. The data center 12 is communicable with the network gateway 14 over standard network protocols, including hypertext transfer protocol (HTTP), commonly used for networked communications. The network gateway 14 is preferably configured for relaying data between the Internet and a Global System for Mobile Communications (GSM) network. However, other digital and cellular networks employed by mobile telephone service providers are equally well suited to the system 10 of the present invention. Communication between the network gateway 14 and the mobile device 16 passes through a carrier center 18 that is adapted for receiving and distributing data between the network gateway 14 and the mobile device 16. In particular, data communication is preferably exercised through a particular protocol known as Short Message Service (SMS), more commonly known as text messaging.

The present invention is further adapted for additional communication means that may utilize or bypass the network gateway 14. For example, in addition to the SMS protocol, the present invention can be readily adapted for use according to both the Multimedia Messaging System (MMS) and the Wireless Application Protocol (WAP). As is known by those skilled in the art, MMS operates similarly to SMS, but is capable of incorporating graphics as well as video and audio clips in its data stream within 3G networks. In an MMS embodiment, the present invention would preferably still utilize the network gateway 14 for translating HTTP data into the MMS format. WAP is an open international standard used for wireless communication that provides Internet access to mobile device. As known by those skilled in the art, WAP suites are compatible with HTTP and HTTPS data formats, and thus any embodiment of the present invention utilizing WAP is adapted to do so without the network gateway 14, as direct communication between the data center 12 and the mobile device 16 is readily afforded.

The data center 12 includes a number of components that permit user access through the Internet as well as communication of the data to the mobile device 16. In particular, a web user interface 120 allows a user to view and update or modify his or her personal information that is stored on the database server 122. The data center 12 also includes transmitting means 124, such as a software application, for storing and forwarding the user data to the network gateway 14. Moreover, the data center 12 includes receiving means 126, such as a software application, for receiving data from the network gateway 14.

The network gateway 14 includes conversion means 140 for converting HTTP data requests from the data center 12 into SMS or MMS data; and a second conversion means 142 for converting SMS or MMS data received from the carrier center 18 into HTTP data receivable by the data center 12. Each of these conversion means 140, 142 can be embodied in computer software that is specially adapted according to the present invention for receiving, coding and transmitting data in a specified manner. As the size of SMS or MMS messages is typically limited in size, those data transfers that exceed this limit are divided into multiple SMS or MMS transmissions, with the first transmission indicating the gross number of transmissions to be received. For transmissions that are divided as so, each subsequent packet includes data indicating its order in the overall transmission such that the entirety of the message can be reassembled at the mobile device 16. Therefore, the network gateway 14 divides large transmissions received in HTTP format into multiple transmissions to be delivered via the SMS or MMS format. Conversely, the network gateway 14 compiles a sequence of SMS or MMS messages from the mobile device 16 into one or more HTTP transmissions directed to the data center 12. Alternatively, the network gateway 14 can convert one or more SMS or MMS messages into a series of one or more HTTP transmissions, indicating the gross number of transmissions and the proper order, such that the HTTP transmissions can be readily assembled at the data center 12.

The mobile device 16 includes an SMS/MMS routing system 160, including a port for receiving SMS/MMS message text and the associated power, memory and processing means that are known in the art of mobile telephony. An embedded application 162, such as a MIDlet or other mobile information device software program, is operable on the mobile device 16 and connectable to the SMS/MMS routing system 160. The embedded application 162 includes a plurality of modules that operate in concert to permit a user to store, access and edit the emergency data. For example, a first module 164 operates to merge or configure the SMS/MMS data as received from the SMS/MMS routing system 160, which may include the process of merging multiple SMS/MMS messages into a single data stream. A database 166 is included in the embedded application 162 for receiving and storing the merged or configured SMS/MMS messages. A data entry module 168 is also in communication with the database 166, permitting a user to input and save data on his or her mobile device 16. The data entry module 168 may include software that recognizes text as entered by a user as well as the capacity to distinguish between distinct fields of data entry related to the user's emergency data. The data entry module 168 is in further communication with a display 170, which includes the necessary software and hardware components for viewing the text of an SMS/MMS message and other data. Lastly, the data entry module 168 is in communication with an SMS/MMS composition module 172 that receives, formats and readies for delivery any SMS/MMS message text or data that is entered by the user. The SMS/MMS composition module 172 is in turn in communication with the SMS/MMS routing system 160 for directing outbound data from the mobile device 16.

In order to deliver the emergency data to the mobile device 16, the data center 12 preferably sends a sequence of HTTP messages to the network gateway 14. The preferred GET/POST parameters of the HTTP request are: USERNAME, PASSWORD, TEXT, PHONE, and PORT. The first two of these parameters provide access to the user's account and verify, in conjunction with the user's phone number, the identity of the user. The TEXT parameter of the HTTP request includes the emergency data to be provided, which may be divided into multiple SMS/MMS messages as described above. The PORT parameter identifies the port within the mobile device 16 through which SMS/MMS messages are routed.

Multiple SMS/MMS messages containing the emergency data are compiled and stored by the embedded application 162. As the first incoming message always indicates the total number of SMS/MMS transmissions in the string, the embedded application 162 can ensure that the entire data transmission is received. Subsequent portions of each transmission contain identifying data for determining the proper order of the SMS/MMS messages such that the embedded application 162 can assemble them in the proper order.

An identical process is performed by the network gateway 14, which may receive and compile multiple SMS/MMS messages from the mobile device 16 and convert them into one or more HTTP transmissions to the data center 12. Each of the SMS/MMS transmissions is tagged with a short code at its beginning that specifies an account on the network gateway 14 as well as a unique URL to which the HTTP transmissions will be directed for storage, modification and viewing on the data center 12. Conversely, as noted above, the network gateway 14 can be adapted for converting the SMS/MMS messages into divided HTTP transmissions for reassembly at the data center 12.

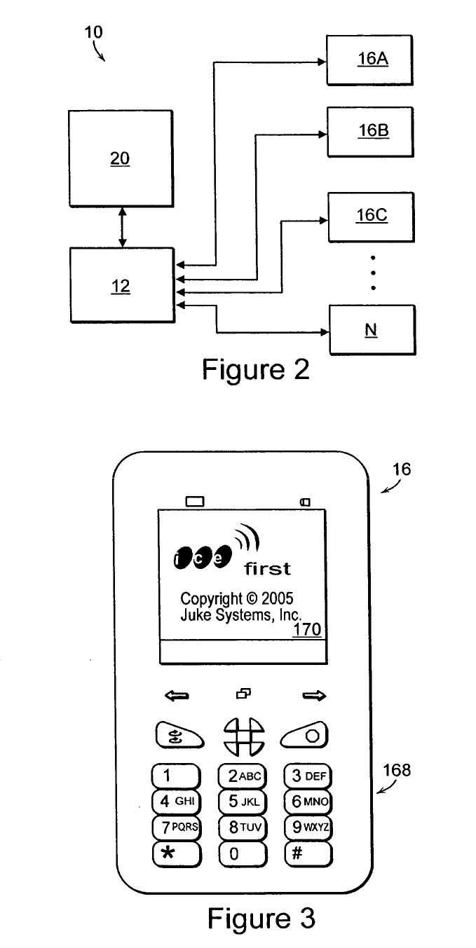

The system 10 of the present invention insures that a user's emergency data is available on his or her mobile device 16, and further that the emergency data is properly updated in a timely manner. A general schematic diagram of the system 10 of the present invention is shown in FIG. 2, including the data center 12, a website 20 or other network access to the data center 12, and a plurality of mobile devices 16a . . . N. In preferred embodiments, the website 20 provides connection to or otherwise interfaces with the web user interface 120 described above. Similarly, the website 20 is usable by a user for accessing the data center 12, which is in communication with the plurality of mobile devices 16a . . . N according to the methods described herein. The website 20 is accessible via the Internet through conventional means, including all types of networked computers, personal digital assistants and mobile telephones that are web-enabled.

In operation, the user can enter and update his or her emergency data on the system 10 either through the website 20 or directly onto his or her mobile device 16. As the mobile device 16 is in regular, but not necessarily constant, communication with the data center 12, the user is ensured of having up-to-date emergency data at his or her disposal at all times. Thus, if the user opts to enter data on his or her mobile device 16, an SMS/MMS message containing the data will be forwarded to the network gateway 14, converted into an HTTP format and then delivered to the data center 12. Conversely, if the user accesses his or her data on the website 20 through the Internet, the updated data will be delivered to the network gateway 14 according to HTTP protocols, and subsequently converted into one or more SMS/MMS messages for delivery to the mobile device 16. Alternatively, the website 20 can be configured to divide the HTTP message into multiple parts, each identifying its order of transmission, such that the network gateway 14 will convert the multiple HTTP transmissions into multiple SMS/MMS messages for delivery to the mobile device 16.

According to an alternate embodiment of the present invention, the mobile device 16 can be configured with a WAP software suite that enables the mobile device 16 to have direct access to the website 20 through the Internet. As WAP is adapted for data transfer according to a protocol similar to HTTP, i.e. Wireless Session Protocol (WSP), and thus the mobile device 16 is capable of communicating with the data center 12 through the website 20 without support from the network gateway 14.

As noted above, the embedded application 162 is operable on the mobile device 16. Optionally, the embedded application 162 may be installed on the mobile device 16 at the discretion of the carrier to which the user subscribes. Alternatively, the embedded application 162 may be downloaded and installed on the mobile device 16 through the system 10 described above. That is, a user can access the data center 12 through an appropriately directed SMS/MMS message that will prompt the data center 12 to respond in kind with the embedded application 162 and associated download and installation protocols. The embedded application is preferably adapted to operate in the background of the mobile device 16 systems at all times. Additionally, under both MIDP 2.0 and Binary Run-Time Environment for Wireless (BREW) enabled mobile devices 16, the embedded application 162 can be invoked remotely through an SMS/MMS message. Other suitable “push” technology, known to those skilled in the art of mobile networking, is also suitable for remotely invoking the embedded application 162.

The embedded application 162 preferably conforms to the J2ME/MIDP specifications; and therefore it can be installed and operated on any J2ME/MIDP enabled mobile devices 12. Such devices are commonly known to those skilled in the art. It should be understood however, that alternate software specifications and mobile device capabilities may be available through a variety of carrier services, and therefore the scope of the present invention is not limited to those configured for the preferred embodiments described herein. For example, a WAP-enabled embedded application 162 will necessarily conform to those standards and protocols that are known by those in the art for wireless Internet access.

In operation, the embedded application 162 may run continuously on the mobile device 16 in such a manner that the user can select and interface directly with the embedded application 162, i.e. through an icon or menu item displayable on the display 170. FIG. 3 is illustrative of a typical mobile device 16 that is presently operating the embedded application 162. As previously noted, the mobile device 16 preferably includes at least a display 170 and a data entry module 168, such as a keypad, voice recognition software, optical recognition software or other suitable means for user interface with a software program.

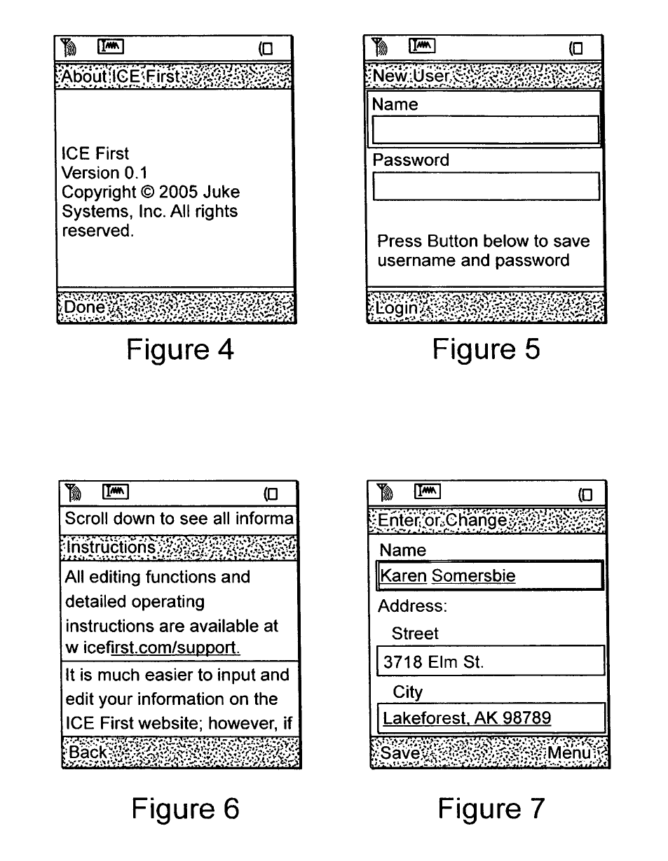

FIG. 4 is a screen shot of a display 170 operating the embedded application 162 in accordance with the present invention. The view of FIG. 4 is an initialization of the embedded application 162 as seen by a typical user, and FIG. 5 is a login screen that a user can utilize to secure his or her emergency data. The username and password provided by the user are identical to those that secure the web-access to the emergency data through the data center 12. While the user has the option of securing his or her emergency data on the mobile device 16, it may also be preferable to freely permit access to the data in case of emergency. For example, a first responder or emergency service provider can readily utilize the mobile device 16 to access the user's emergency data, provided that access to the information is not hindered by a password requirement. Accordingly, users may opt out of the password protection for viewing their emergency data on the mobile device 16, although the username and password must be utilized to edit data on the mobile device 16 and the data center 12 as described further below.

Upon entry into the embedded application 162, the display 170 will show an instruction screen, available through a menu selection, like that illustrated in FIG. 6. Included in the instructions for the system 10 of the present invention is a URL address for accessing the data center 12 through the World Wide Web. Additionally, a user can use his or her mobile device 16 to scroll down through additional instructions, which include information on how to enter or update the information stored on the mobile device 16. As previously noted, any information that is entered or updated via the embedded application 162 is immediately directed from the mobile device 16 to the network gateway 14 in one or more SMS/MMS messages or through the Internet in a WAP embodiment, from whence the emergency data updates are directed back to the data center 12 in HTTP format.

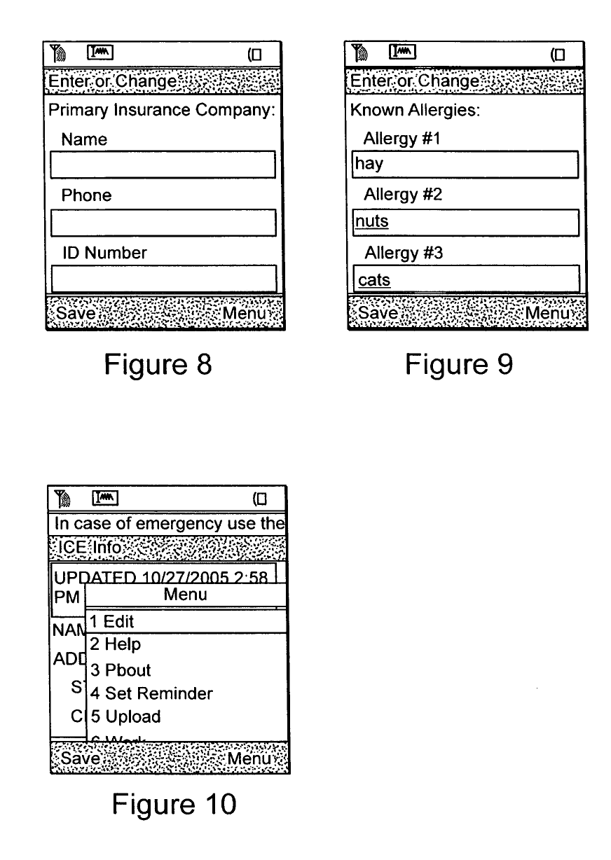

Entry of emergency data through the mobile device 16 and embedded application 162 is accomplished through a series of fields that are organized in an easily viewable and understandable fashion. FIG. 7 is a screen shot of the mobile device 16 depicting an emergency data field related to the user's personal information, including at least his or her name and address. FIG. 8 is a screen shot of the mobile device 16 depicting an emergency data field related to the user's primary insurance information, including at least the name of the insurance provider, contact information for the insurer, and the user's ID number. FIG. 9 is a screen shot of the mobile device 16 depicting an emergency data field related to allergies that the user might have. Each of the fields organized within the data structure of the present invention might include a plurality of subfields, as shown in FIGS. 7, 8 and 9. Thus, for the emergency data field corresponding to known allergies, there are multiple subfields for entering distinct allergies, such as for example, hay, nuts and cats.

The data structure of the present invention includes a number of fields that are relevant to a user and a first responder in an emergency situation. In addition to personal information, insurance information and allergies, the data fields of the present invention include at least those shown in Table 1.

TABLE 1

| Field | Subfields |
|---|---|
| Identification | Name |
| | Address |
| | City, State, Zip Code |
| Telephone number | Home Phone |
| | Work Phone |
| | Mobile Phone |
| Next of Kin | Name |
| | Contact Information |
| | Emergency Contact (Y/N) |
| Primary Physician | Name |
| | Contact Information |
| Primary Dentist | Name |
| | Contact Information |
| Emergency Contact | Name |
| | Contact Information |
| Emergency Contact 2 | Name |
| | Contact Information |
| Primary Insurance | Name |
| | Contact Information |
| | ID Number |
| | Group Number |
| | Primary Insured's Name |
| Secondary Insurance | Name |
| | Contact Information |
| | ID Number |
| | Group Number |
| | Secondary Insured's Name |
| Living Will | Attorney Name |
| | Attorney Contact Information |
| | DNR Instructions |
| Driver's License | State, Number |
| Birthdate | |
| Pregnancy | Estimated Due Date |
| Known Allergies | Allergy 1 |
| | Allergy 2 |
| | Allergy 3 |
| Medications | Name |
| | Dosage |
| Dependant 1 | Name |
| | Birthdate |
| | Known Allergies |
| | Medications |
| Dependant 2 | Name |
| | Birthdate |
| | Known Allergies |
| | Medications |
| Vision | Glasses/Contact Lenses |
| Pacemaker | Y/N |

While not an exhaustive list of categories of emergency data, Table 1 is illustrative of the types of fields and subfields that are organized within the data structure of the present invention. On the mobile device 16, viewing of the fields and subfields is accomplished through menu selection, which can be accomplished by scrolling through a series or list of fields and then selecting a field.

According to the data organization set forth above, the data storage and transmission between the data center 12 and the mobile device 16 is structured as a sequence of pairs. The first element of each pair designates a field or subfield and the second element of each pair includes the content related to that element. Thus a typical entry may include the pair NAME: JOHN H. DOE or KNOWN ALLERGY: PENICILLIN. In this manner, each storing, receiving and transmitting means described above can accurately and definitively organize and display the necessary emergency data.

It is an additional feature of the present invention that multiple fields and subfields can be configured for each user. As such, a user can enter any number of dependants in his or her emergency data. Conversely, if a field remains unpopulated with any added or edited data, then that field will not be shown by the embedded application 162 on the mobile device. Therefore, if a user has no dependants, or no secondary insurer, then those fields will not be viewable on the mobile device 16. For specified fields, such as KNOWN ALLERGY and MEDICATIONS, a user may select a subfield NONE, which will accurately convey to a first responder that the field was considered and not left blank because of user oversight.

Nevertheless, a user can create and update any field, including those not previously selected and viewable, through the mobile device 16 as shown in the screen shot of FIG. 8. The menu shown in FIG. 10 is displayable as a secondary window within the display 170, or through any other conventional means of organizing data for viewing that is known to those skilled in the art. As shown in the MENU, the user is presented with a variety of options, including at least an EDIT function, a HELP function, an ABOUT function, a SET REMINDER function, and an UPLOAD function. Other MENU functions, such as a TEST function, are also available as part of the embedded application 162. Each of these functions is available to the user via the mobile device 16 configured with the embedded application 162 as well as the data center 12 through the web user interface 120.

For example, the SET REMINDER function of the present invention is usable through both means described above. This particular function allows a user to set an alarm or other time-dependent notification that automatically directs a message to the mobile device 16. For example, the user may set an alarm or reminder function for informing him or her that the emergency data should be checked and updated. Alternatively, the SET REMINDER function can embody an active alarm. If, given the passage of a predetermined amount of time, the user does not respond to the incoming reminder message, the system 10 of the present invention assumes that the user is in an emergency situation and it automatically contacts the user's emergency contact via SMS/MMS message (through the HTTP transfer described above) or voice mail. The message or voicemail to the emergency contact will inform the emergency contact that the user is non-responsive to his or her mobile device, at which time the emergency contact may take the appropriate initiatives.

Automated means for responding to the SET REMINDER notification are also provided by the present invention. For example, the mobile device 16 is communicable with at least the service provider network, which is capable of determining whether the mobile device 16 is stationary or in motion based upon any transitions between service terminals. Provided that the user is in motion, the embedded application 162 will note the transition between service terminals and relay a response message back to the data center 12 via SMS/MMS. In another embodiment, the mobile device 16 can include a Global Positioning System (GPS) or other tracking device (not shown) that provides information related to the user's position. Provided that the user is in motion, the embedded application 162 will receive the necessary data from the GPS and relay a response message via SMS/MMS back to the data center 12.

The present invention also includes means, such as translation software, that is adapted for updating or altering a user's emergency data according to a local language. As the mobile device 16 may be configured for determining a user's position, as described above, it is a feature of the present invention that the mobile device 16 is adapted for determining whether a user has moved between countries. For example, an American user may travel to another continent, such as Europe or Asia, in which English is not the primary language understood by first responders. In such a case, the embedded application 162 is adapted for changing the language of the fields and selected subfields based upon the local language of the place in which the user is located. This determination is made in response to positioning data that can be determined by the mobile device 16 through a GPS unit or through its interaction with a service provider terminal.

In another embodiment, a user's emergency data stored on the data center 12 is adapted for communication and synchronization with a third-party data recipient, through conventional software means such as JAVA™ Applet includable on an HTML page. In such a manner, a user's emergency data can be remotely retrieved from the data center 12 without utilizing the mobile device 16, which in some emergency events may be lost or destroyed. In summary, the present invention includes a novel system and method for the storage, organization, transmission and receipt of emergency data for any number of potential users. While the description above focused on the present invention as applied to a single set of transactions between a mobile device and a data center, it should be understood that in operation the present invention might encompass many networked data centers in communication with any number of mobile devices. More importantly, although the present invention is described in detail with reference to its preferred embodiments, it should be understood that trivial variations from those embodiments can be readily devised by those skilled in the art without departing from the scope thereof as defined in the following claims.

We claim:

1. A method for communicating emergency data comprising:
accessing a database of information, the database of information including emergency data for an individual, the database of information available to the individual through a network;
routing the emergency data through communications means, the communications means adapted for receiving the emergency data related to the individual from the database according to a first protocol; and
accessing the emergency data related to the individual, the emergency data being transmitted from the communications means to a mobile device, the emergency data transmittable from the communications means according to a second protocol.

2. The method of claim 1 wherein the first protocol is hypertext transfer protocol (HTTP).

3. The method of claim 1 wherein the second protocol is short message service (SMS).

4. The method of claim 1 wherein the second protocol is multimedia message service.

5. The method of claim 1 wherein the second protocol is wireless application protocol (WAP).

6. The method of claim 1 wherein the mobile device is a wireless telephone.

7. The method of claim 6 wherein the wireless telephone is adapted for receiving SMS messages.

8. The method of claim 1 wherein the communications means is a network gateway for converting an HTTP request into one of an SMS message or an MMS message.

9. The method of claim 1 wherein the step of receiving the emergency data from the communications means includes receiving an HTTP request having a plurality of parameters associated therewith.

10. The method of claim 9 wherein the plurality of parameters include a username, a password, a text, a phone number, and a phone port for receiving an SMS message.

11. The method of claim 1 further comprising the step of transmitting the emergency data from the communications means to the mobile device, including the step of transmitting more than one message to the mobile device, the first of which including data indicating the total number of messages being sent thereto.

12. The method of claim 1 wherein the emergency data for the individual is parsed into a set of fields.

13. The method of claim 1 further comprising the step of permitting a user to update his or her emergency data through a web user interface.

14. The method of claim 1 further comprising the step of permitting a user to update his or her emergency data through the mobile device.

15. The method of claim 14 wherein the step of permitting a user to update his or her emergency data includes the step of permitting selective access to the database by the user through a networked computer.

16. The method of claim 1 further comprising the step of synchronizing the emergency data on the database with the emergency data on the mobile device through repeated transmissions of the emergency data through the communications means.

17. A system for communicating emergency data including a database containing emergency data for at least one individual, the database connectable to a network and further adapted for communication with a communications means according to a first protocol, the system comprising:
a mobile device adapted for communication with the communications means, the mobile device further adapted for receiving emergency data from the communications means according to a second protocol, the second protocol distinct from the first protocol; and
at least a second mobile device adapted for communication with the communications means, the mobile device further adapted for receiving emergency data from the communications means according to the second protocol, the second protocol distinct from the first protocol.

18. The system of claim 17 wherein the second protocol is a short message service (SMS) protocol.

19. The system of claim 17 wherein the second protocol is a multimedia message service (MMS) protocol.

20. The system of claim 17 wherein the second protocol is a wireless application protocol (WAP).

21. The system of claim 17 wherein the mobile device is a wireless telephone.

22. The system of claim 17 wherein the at least a second mobile device is a wireless telephone.

23. The system of claim 17 wherein the emergency data is contained within a communication directed to the mobile device from the communications means.

24. The system of claim 17 wherein the communication is delivered in a series including a first message and one or more subsequent messages, the first message containing information relating to the total number of messages within the series.

25. The system of claim 17 wherein the emergency data is parsed into a series of fields.

26. The system of claim 17 wherein the mobile device comprises display means for displaying the emergency data to a user.

27. The system of claim 17 wherein the mobile device comprises inputting means for permitting a user to update the emergency data.

28. The system of claim 17 wherein the first mobile device further comprises means for determining the location of the first mobile device and determining a language for displaying the emergency data in response thereto.

29. The system of claim 17 further comprising means for reminding a user to update his or her emergency data.

30. The system of claim 29 wherein the means for reminding a user further includes means for contacting an emergency contact specified by the user in response to a user's failure to communicate with the system.
